(19) United States
(12) Patent Application Publication
(10) Pub. No.: US 2026/0029021 A1
(43) Pub. Date: Jan. 29, 2026

(54) THIN SECTION BEARING AND COMPUTER TOMOGRAPH HAVING A THIN SECTION BEARING OF THIS TYPE

(71) Applicant: Schaeffler Technologies AG & Co. KG, Herzogenaurach (DE)

(72) Inventors: Dietmar Rudy, Kleinbundenbach (DE); Michael Pausch, Dittelbrunn (DE); Carsten Merklein, Nürnberg (DE); Wolfgang Bauer, Riegelsberg (DE); Wolfgang Braun, Garstadt (DE)

(21) Appl. No.: 18/994,362

(22) PCT Filed: Mar. 14, 2023
(86) PCT No.: PCT/DE2023/100191

§ 371 Date: Jan. 14, 2025

(30) Foreign Application Priority Data
Jul. 14, 2022 (DE) 10 2022 117 646.0

(51) Int. Cl. F16C 33/58; F16C 19/06; F16C 33/62

(52) U.S. Cl. CPC F16C 33/585; F16C 19/06; F16C 33/62

(57) ABSTRACT

The invention relates to a thin section bearing (1, 1′), in particular for a computer tomograph, comprising at least one inner ring (2, 2a, 2b), at least one outer ring (3, 3a, 3b) and a plurality of spherical rolling elements (4), wherein: the at least one inner ring (2, 2a, 2b) has an inside diameter (Di) of greater than 700 mm; the at least one outer ring (3, 3a, 3b) and the at least one inner ring (2, 2a, 2b) are made of an unhardened metal base material (6) having a hardness of less than 58 HRC; the at least one outer ring (3, 3a, 3b) and the at least one inner ring (2, 2a, 2b) each form at least one raceway region (7a, 7b, 7c, 7d) in contact with the rolling elements (4); and the base material (6) is laser-hardened in the at least one raceway region (7a, 7b, 7c, 7d), and the raceway region (7a, 7b, 7c, 7d) has a hardness of at least 58 HRC.

### CROSS-REFERENCE TO RELATED APPLICATION

The present application is the U.S. National Phase of PCT Patent Application Number PCT/DE2023/100191, filed on Mar. 14, 2023, which claims priority to German Patent Application Number 10 2022 117 646.0, filed Jul. 14, 2022, the entire disclosures of which are incorporated by reference herein.

### TECHNICAL FIELD

The disclosure relates to a thin section bearing comprising at least one outer ring, at least one inner ring and a plurality of spherical rolling elements, wherein the at least one inner ring has an inside diameter of greater than 700 mm, in particular for use in a computer tomograph.

### BACKGROUND

DE 10 2009 056038 A1 describes a thin section bearing and a method for producing a bearing ring from material in the form of wire for a thin section bearing. The wire is rolled, bent and the free ends are welded together. The resultant solid ring is then annealed and finally cold rolled and optionally hardened.

Thin section bearings are rolling bearings that have a large inside diameter Dᵢ of the inner ring in relation to the distance A between the inside diameter and the outer diameter of the bearing (seen in cross-section). In particular, the A/Dᵢ ratio=1:30 to 1:150.

DE 10 2007 049 071 A1 describes a wire race bearing with two concentrically arranged support rings, which have guide wires in recesses facing each other, between which rolling elements roll on associated raceways. The wire race bearing is configured as a four-point ball bearing and is used as a rotary joint in computer tomography.

DE 10 2004 062 116 B3 discloses a bearing arrangement for a medical device such as a computer tomograph. The bearing arrangement has a one-piece inner ring and a one-piece outer ring, each with a hollow cylindrical basic contour.

DE 10 2017 222 208 B3 describes a computed tomography device and a method for arranging a bearing ring of a rolling bearing. It is stated therein that computer tomography devices typically have a stationary part and a rotating part, wherein the rotating part has a radiation source for X-rays and an X-ray detector that interacts with the radiation source. The rotating part can have a mass of, for example, about 600 to 900 kg and rotate at a speed of about 60 to 240 revolutions per minute. Very precise, smooth and noiseless running of the rotary movement is essential. The rotational movement of the rotating part can be driven by means of a direct drive or by means of a drive belt that interacts with a pulley of the rotating part. A rolling bearing can be used to pivot the rotating part relative to the stationary part. A rolling bearing has a plurality of rolling elements and a number of raceways for rolling the rolling elements.

High degree of running accuracy, extreme smoothness, freedom from play and a high degree of tilting rigidity are essential to produce high-quality images. To date, bearing rings made of high-purity and therefore expensive steel grades, which are usually completely hardened, have been used for this purpose. Stresses and distortion of the bearing rings often occur during the hardening process.

### SUMMARY

It is therefore an object of the disclosure to provide a suitable thin section bearing which brings about cost savings with regard to its production as well as a reduction in thermal distortion in the hardening process.

The object is achieved by a thin section bearing comprising at least one inner ring, at least one outer ring and a plurality of spherical rolling elements, wherein the at least one inner ring has an inside diameter Dᵢ of greater than 700 mm, wherein the at least one outer ring and the at least one inner ring are made of an unhardened metal base material having a hardness of less than 58 HRC, wherein the at least one outer ring and the at least one inner ring each form at least one raceway region in contact with the rolling elements, and wherein the base material is laser-hardened in the at least one raceway region and the raceway region has a hardness of at least 58 HRC.

Distortion of the bearing rings is minimized due to laser hardening of the at least one inner ring and the at least one outer ring only being carried out locally. The inexpensive, unhardened metal base material is only hardened in a region that comes into contact with the rolling elements and forms a raceway for the rolling elements. This leads to significant cost savings in the production of a thin section bearing.

However, to improve the microstructure, it has been proven effective to temper the metal base material to a hardness of 250+100 HV before laser hardening.

It is preferred if the metal base material is made of steel having a proportion of
0.38 to 0.56 wt. % C,
0.3 to 1.2 wt. % Mn,
0.9 to 1.2 wt. % Cr,
0.15-0.30 wt. % Mo,
balance iron and unavoidable impurities or other elements, such as Si, Al, P, S, Pb, having a proportion of less than 0.5 wt. %. This is inexpensive, can be laser-hardened and can be used for the thin section bearing according to the disclosure. In particular, steels of grade 1.7228 (50CrMo4) or 1.7225 (42CrMo4) have proven effective.

It is preferred for an outer ring and an inner ring to be present, each having two raceway regions arranged separately from one another and running annularly and parallel to one another. The two raceway regions are preferably separated from each other by an annular groove. The groove serves as a lubricant reservoir and prevents the heat-affected zones of two raceway regions from overlapping.

Alternatively, it has been proven effective to have two outer rings and/or two inner rings, each of which has an annular raceway region. The two outer rings and/or the two inner rings can have local recesses in a region where their raceways adjoin one another.

A free surface of the at least one raceway region, which forms a raceway for the rolling elements, can be machined and/or rolled. The free surface of the at least one raceway region, which forms a raceway for the rolling elements, is in particular honed.

The at least one raceway region is preferably of different thicknesses as viewed across a cross-section through the at least one outer ring or the at least one inner ring. Preferably, the penetration depth of the laser hardening in the base material is at its greatest in the region of a contact angle progression.

A computer tomograph comprising at least one thin section bearing according to the disclosure has proven itself with regard to the achievable high degree of running accuracy, extreme running smoothness, freedom from play and high degree of tilting rigidity of the thin section bearing.

### BRIEF DESCRIPTION OF THE DRAWINGS

FIGS. 1 to 4 are intended to illustrate thin section bearing according to the disclosure by way of example. In the figures:

FIG. 1 shows a section through a first thin section bearing having an outer ring and an inner ring;

FIG. 2 shows a magnified detail of the first thin section bearing according to FIG. 1 in the region of the sectioned surfaces;

FIG. 3 shows a section through a second thin section bearing with two outer rings and two inner rings; and

FIG. 4 shows a magnified detail of the second thin section bearing according to FIG. 3 in the region of the sectioned surfaces.

### DESCRIPTION OF PREFERRED EXEMPLARY EMBODIMENTS

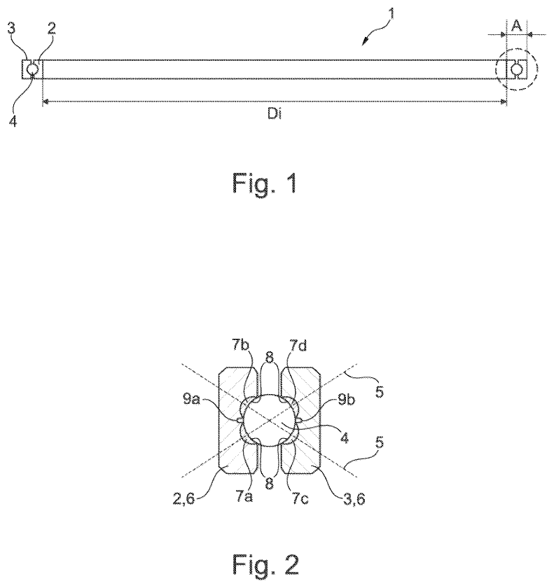

FIG. 1 shows a section through a first thin section bearing 1 having an outer ring 3 and an inner ring 2. Furthermore, a plurality of spherical rolling elements 4 are present. The inner ring 2 has an inside diameter Dᵢ of greater than 1 m. The outer ring 3 and the inner ring 2 are made of an unhardened metal base material 6 with a hardness of less than 58 HRC (see FIG. 2). The outer ring 3 and the inner ring 2 each form at least one raceway region 7a, 7b, 7c, 7d in contact with the rolling elements 4. The base material 6 is laser-hardened in the raceway regions 7a, 7b, 7c, 7d and the raceway regions 7a, 7b, 7c, 7d have a hardness of at least 58 HRC. The A/Dᵢ ratio is in the range 1:30 to 1:150, wherein the distance A between the inside diameter Dᵢ and an outer diameter of the thin section bearing 1 (seen in cross-section) is recorded. The outer ring 3 and the inner ring 2 each have two raceway regions 7a, 7b; 7c, 7d, arranged separately from each other and running annularly and parallel to one another, which raceway regions are separated from one another by an annular groove 9a, 9b.

FIG. 2 shows a magnified detail of the first thin section bearing 1 according to FIG. 1 in the region of the sectioned surfaces (see region circled with a dashed line in FIG. 1). The contact angles 5 are indicated by dashed lines in FIG. 2. The hardening depth in the base material 6 is at its greatest in the areas of the raceway regions 7a, 7b, 7c, 7d which intersect the contact angles 5. A free surface 8 of the raceway regions 7a, 7b, 7c, 7d in each case forms a raceway for the rolling elements 4.

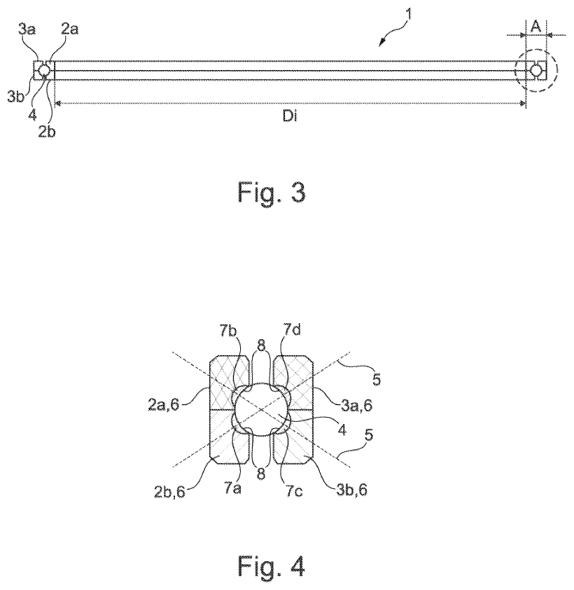

FIG. 3 shows a section through a second thin section bearing 1′ with two outer rings 3a, 3b and two inner rings 2a, 2b. Furthermore, a plurality of spherical rolling elements 4 are present. The inner rings 2a, 2b have an inside diameter Dᵢ of greater than 700 mm. The outer rings 3a, 3b and the inner rings 2a, 2b are made of an unhardened metal base material 6 with a hardness of less than 58 HRC (see FIG. 4). The outer rings 3a, 3b and the inner rings 2a, 2b each form a raceway region 7a, 7b, 7c, 7d in contact with the rolling elements 4. The base material 6 is laser-hardened in the raceway regions 7a, 7b, 7c, 7d and the raceway regions 7a, 7b, 7c, 7d have a hardness of at least 58 HRC. The A/Dᵢ ratio is in the range 1:30 to 1:150, wherein the distance A between the inside diameter Dᵢ and an outer diameter of the thin section bearing 1′ (seen in cross-section) is recorded. The outer rings 3a, 3b and the inner rings 2a, 2b each have an annular raceway region 7a, 7b; 7c, 7d.

FIG. 4 shows a magnified detail of the second thin section bearing 1′ according to FIG. 3 in the region of the sectioned surfaces (see region circled with a dashed line in FIG. 3). The contact angles 5 are indicated by dashed lines in FIG. 4. The hardening depth in the base material 6 is at its greatest in the areas of the raceway regions 7a, 7b, 7c, 7d which intersect the contact angles 5. A free surface 8 of the raceway regions 7a, 7b, 7c, 7d in each case forms a raceway for the rolling elements 4.

### LIST OF REFERENCE SYMBOLS

1, 1′ Thin section bearing
2, 2a, 2b Inner ring
3, 3a, 3b Outer ring
4 Rolling element
5 Contact angle
6 Base material
7a, 7b, 7c, 7d Raceway region
8 Free surface of the raceway region or raceway
9a, 9b Annular groove
A Distance
Dᵢ inside diameter

1. A thin section bearing comprising at least one inner ring, at least one outer ring, and a plurality of spherical rolling elements, wherein the at least one inner ring has an inside diameter of greater than 700 mm, wherein the at least one outer ring and the at least one inner ring are made of an unhardened metal base material having a hardness of less than 58 HRC, wherein the at least one outer ring and the at least one inner ring each form at least one raceway region in contact with the rolling elements, and wherein the base material is laser-hardened in the at least one raceway region and the raceway region has a hardness of at least 58 HRC.

2. The thin section bearing according to claim 1, wherein the metal base material is made of steel comprising:
0.38 to 0.56 wt. % C,
0.3 to 1.2 wt. % Mn,
0.9 to 1.2 wt. % Cr,
0.15-0.30 wt. % Mo.

3. The thin section bearing according to claim 1, wherein an outer ring and an inner ring are present, each having two raceway regions arranged separately from one another and running annularly and parallel to one another.

4. The thin section bearing according to claim 3, wherein the two raceway regions are separated from one another by an annular groove.

5. The thin section bearing according to claim 1, wherein the at least one outer ring comprises two outer rings and the at least one inner ring comprises two inner rings, each having an annular raceway region.

6. The thin section bearing according to claim 1, wherein a free surface of the at least one raceway region, which forms a raceway for the rolling elements, is machined and/or rolled.

7. The thin section bearing according to claim 6, wherein the free surface of the at least one raceway region, which forms a raceway for the rolling elements, is honed.

8. The thin section bearing according to claim 1, wherein the at least one raceway region is of different thicknesses as viewed across a cross-section through the at least one outer ring or the at least one inner ring.

9. A computer tomograph comprising at least one thin section bearing according to claim 1.

10. A thin section bearing comprising:
at least one inner ring;
at least one outer ring; and
a plurality of spherical rolling elements,
wherein the at least one outer ring and the at least one inner ring are made of an unhardened metal base material, wherein the at least one outer ring and the at least one inner ring each form at least one raceway region in contact with the rolling elements, and wherein the raceway region has a hardness greater than a hardness of the unhardened metal base material of the at least one outer ring and the at least one inner ring.

11. The thin section bearing according to claim 10, wherein the at least one inner ring has an inside diameter of greater than 700 mm.

12. The thin section bearing according to claim 10, wherein the at least one outer ring or the at least one inner ring are formed from unhardened metal base material having a hardness of less than 58 HRC.

13. The thin section bearing according to claim 10, wherein the raceway region has a hardness of at least 58 HRC.

14. The thin section bearing according to claim 10, wherein the metal base material comprises steel, wherein the steel comprises: 0.38 to 0.56 wt. % C,
0.3 to 1.2 wt. % Mn,
0.9 to 1.2 wt. % Cr,
0.15-0.30 wt. % M.

15. The thin section bearing according to claim 10, wherein the at least one outer ring and the at least one inner ring each include two raceway regions.

16. The thin section bearing according to claim 15, wherein the two raceway regions are separated from one another by an annular groove.

17. The thin section bearing according to one of claim 10, wherein the at least one outer ring comprises two outer rings and the at least one inner ring comprises two outer rings.

18. A computed tomography machine comprising:
a thin section bearing, wherein the thin section bearing comprises:
at least one inner ring;
at least one outer ring; and
a plurality of spherical rolling elements,
wherein the at least one outer ring and the at least one inner ring are made of an unhardened metal base material, wherein the at least one outer ring and the at least one inner ring each form at least one raceway region in contact with the rolling elements, and wherein the raceway region has a hardness greater than a hardness of the unhardened metal based material of the at least one outer ring and the at least one inner ring.

19. The computed tomography machine according to claim 18, wherein the at least one outer ring and the at least one inner ring each include two raceway regions.

20. The computed tomography machine according to claim 18, wherein the at least one outer ring comprises two outer rings and the at least one inner ring comprises two outer rings.
